(19) United States
(12) Patent Application Publication
(10) Pub. No.: US 2017/0044075 A1
(43) Pub. Date: Feb. 16, 2017

(54) UREA FERTILIZERS COATED WITH PLANT AVAILABLE FORMS OF BORON

(71) Applicant: Compass Minerals Manitoba, Inc., Winnipeg (CA)

(72) Inventor: Mark Goodwin, Winnipeg (CA)

(21) Appl. No.: 15/234,704

(22) Filed: Aug. 11, 2016

Related U.S. Application Data
(60) Provisional application No. 62/204,034, filed on Aug. 12, 2015.

(51) Int. Cl. C05C 9/00; C05G 3/00

(52) U.S. Cl. CPC C05C 9/005; C05G 3/0041

(57) ABSTRACT

Described herein are urea prills coated with a fine powder of plant-available boron which have reduced volatilization of nitrogen compared to untreated urea prills during the early stages of plant growth. As a result, more nitrogen is available to the plant during early plant growth. Furthermore, the boron-urea prill fertilizer product also provides boron in a plant available form which also promotes early plant growth.

### PRIOR APPLICATION INFORMATION

The instant application claims the benefit of U.S. Patent Application, filed Aug. 12, 2015, Ser. No. 62/204,034, entitled ‘UREA FERTILIZERS COATED WITH PLANT AVAILABLE FORMS OF BORON’, the contents of which are incorporated herein by reference.

### BACKGROUND OF THE INVENTION

No-till/conservation agriculture is an environmentally friendly approach that involves little or no disturbance of the topsoil, resulting in less soil erosion and less energy-intensive operation. However, most N fertilizers are not suited for such (surface) application. Surface application of N fertilizers results in gaseous losses of ammonia and damage to seedlings from ammonium-N.

Improving nitrogen use efficiency due to the current low use efficiency of 35-50% for urea use is crucial for both economic and environmental reasons.

Volatilization of ammonia occurs when urea is broken down in the soil. Urease, which is found in bacteria, fungi and some higher plants, catalyzes the hydrolysis of urea ultimately into carbon dioxide, ammonia and water. A portion of the ammonia may be held by absorbing constituents of the soil and will be available to plants; however, a significant portion of the ammonia is lost to the air. Furthermore, the accumulation of ammonia in the soil can lead to an increase in soil pH which can reduce plant germination and growth.

Boric acid and other boron compounds have been used as urease inhibitors for reducing ammonia volatilization of urea fertilizers.

One such example is ARBORITE®, where the active ingredient, N-(n-butyl)-thiophosphoric triamide (NBPT), is diluted using a variety of aqueous liquids including mono, di or tri ethanolamine borate, which then may be used to coat fertilizer products.

Published US Patent Application US2012/0067094 teaches a method of producing urea fertilizer having reduced ammonia volatilization wherein a particle containing one or more of boron and iodine mixed with a binder is spray coated with melted urea. Boric acid, sodium tetraborate pentahydrate, sodium tetraborate decahydrate and anhydrous sodium tetraborate are taught therein as suitable borate sources.

U.S. Pat. No. 6,830,603 teaches using a borate solution to coat urea and then removing the water so that a borate salt is formed on the urea. This patent also teaches the addition of fine powders of micronutrients or macronutrients being applied to the coated urea with the borate salt acting as a binding agent.

Published US Patent Application US2010/0175444 teaches a nitrogenous fertilizer such as urea and a polycarboxylated polymer. The composition may also include an amount of boron. In preferred embodiments, the boron is used in conjunction with a vinylic polymer such as polyvinyl alcohol.

U.S. Pat. No. 6,830,603 teaches coating granular urea with a coating that includes a binding agent having a boron anion and a hydrogen bonding group to adhere the binding agent to the granular urea.

U.S. Pat. No. 3,388,989 teaches a fertilizer composition comprising urea, a hydrocarbon binder and a urease inhibitor such as formaldehyde; boron metal salts such as sodium borate and potassium borate; fluorine metal salts and heavy metal ions with atomic weights greater than 50.00.

U.S. Pat. No. 3,523,018 teaches the use of inorganic or organic heavy metal salts such as copper sulfate, borax and addition compounds of cupric cyanide, boron trifluoride, copper formate and copper acetate as urease inhibitors. The granules are formed by incorporating the inhibitor into the urea melt prior to prilling.

U.S. Pat. No. 3,565,599 teaches a fertilizer composition comprising urea, certain hydrophobic chemicals and an inorganic boron compound such as orthoboric acid, sodium perborate, potassium metaborates, tetraboric acid, ammonium pentaborate and ammonium tetraborate. The boron source and the hydrophobic chemical(s) are preferentially distributed in the urea melt prior to prilling.

U.S. Pat. No. 4,462,819 teaches a combination of urea or a compound capable of producing urea when applied to the soil with a urease inhibiting effective amount of one or more organo boron acid compounds.

In a presentation at the ASA-CSSA-SSA Annual Meetings in 2013, Singh et al described the use of urea as a delivery system for boron wherein a small core of urea was prepared using a fluid bed granulation process and the core was then replaced with a micronutrient core, such as boron. This “seed-core” boron with urea resulted in 13-28% less NH3 volatilization loss than urea and was effective under both upland and flooded soil conditions.

As discussed above, nitrogen loss due to volatilization is a major agricultural concern for a variety of reasons. However, when preventing nitrogen loss due to volatilization, care must also be taken that the nitrogen, typically a urea fertilizer prill, is also plant-available. Furthermore, care must also be taken that the agents used to prevent or reduce volatilization at least do not have a negative impact on plant growth and preferably promote plant growth.

Described herein are combination boron-urea prill products which have reduced volatilization of nitrogen compared to untreated urea prills during the early stages of plant growth, thereby making more nitrogen available to the plant during early plant growth. Furthermore, the boron-urea prill fertilizer product also provides boron in a plant available form which also promotes early plant growth, as discussed below.

### SUMMARY OF THE INVENTION

According to a first aspect of the invention, there is provided a method of improving early growth of a plant comprising: providing to a plant, a seed or a seedling a fertilizer product comprising a urea prill coated with a plant-available boron powder wherein the plant available boron powder is applied to the urea prill at a particle size of at least 90% passing through a 100 mesh at 0.1-2.5% (w/w); and growing the plant, the seed or the seedling under suitable growth conditions.

According to a further aspect of the invention, there is provided a urea prill coated with a plant-available boron powder wherein the plant available boron powder is applied to the urea prill at a particle size of at least 90% passing through a 100 mesh at 0.1-2.5% (w/w).

According to another aspect of the invention, there is provided a method of preparing a nitrogen based fertilizer product for plants with reduced ammonia volatilization loss, comprising:

providing a urea prill;

coating said urea prill with a plant-available boron powder;

said boron powder having a particle size of at least 90% passing through a 100 mesh standard screen sieve and being from about 0.1% to about 2.5% (w/w) of the urea prill.

### BRIEF DESCRIPTION OF THE DRAWINGS

FIG. 1. Daily ammonia volatilization loss from N fertilizers applied on Upland Greenville soil.

FIG. 2. Cumulative ammonia volatilization loss from N fertilizers on Greenville soil.

FIG. 3. Cumulative ammonia volatilization loss as a percentage of applied N fertilizer on Greenville soil.

FIG. 4. Comparative growth of corn plants supplied 0.75 g urea, 0.75 g urea coated with 1.25% plant-available boron and 0.75 g urea coated with 0.3% AGROTAIN®.

FIG. 5. Comparative growth of corn plants supplied 1.5 g urea, 1.5 g urea coated with 1.25% plant-available boron and 1.5 g urea coated with 0.3% AGROTAIN®.

### DESCRIPTION OF THE PREFERRED EMBODIMENTS

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described. All publications mentioned hereunder are incorporated herein by reference.

Urea is a white crystalline solid organic compound and manufactured in “prilled” form. Urea prills are formed by dropping liquid urea from a prilling tower into droplets that dry into roughly spherical shapes

While not wishing to be bound to a particular theory or hypothesis, the inventor believes that the combination of reduced nitrogen loss due to less nitrogen volatilization as well as supplying the plant with boron in a plant available form results in a synergistic effect on plant growth which is greater than what one would expect from the addition of boron and urea separately.

Specifically, a fine powder of boron is applied to a urea prill as discussed herein.

Preferably, the boron is a borate sourcing compound or borate ingredient selected from the group consisting of potassium borate, disodium octaborate tetrahydrate, potassium tetraborate tetrahydrate, boric acid and mixtures thereof.

In some preferred embodiments, the plant-available boron powder is a mixture comprising disodium octaborate tetrahydrate, potassium borate and/or potassium tetraborate tetrahydrate and boric acid.

The range of ratios of these three components is 50 to 70 percent of disodium octaborate tetrahydrate; (w/w) 15 to 25 percent of the potassium borate or potassium tetraborate tetrahydrate (w/w) and 10 to 20 percent of the boric acid (w/w). As will be apparent to one of skill in the art, all of the forms of boron recited above are forms that are readily taken up, that is, are plant-available.

Furthermore, potassium borate, disodium octaborate tetrahydrate and potassium tetraborate tetrahydrate are “first uptake” forms of boron. On the other hand, boric acid is a “subsequent uptake” form. As will be apparent to one of skill in the art, a combination of the first uptake and subsequent uptake forms will provide boron to growing plants immediately upon application as well as up to 28 days after application while also reducing nitrogen loss due to volatilization, as discussed herein.

For illustrative purposes, in one example, the disodium octaborate tetrahydrate, the potassium borate and/or potassium tetraborate tetrahydrate may be taken up by a plant for approximately 10-14 days, that is, “first”, while the boric acid may be taken up by a plant from for example 10-14 days after application until for example 28 days after application, that is, subsequent to the uptake of the “first uptake” forms of boron. As will be apparent to one of skill in the art, these time periods are for illustrative purposes and the actual time periods for uptake by a plant will depend on numerous factors, including but by no means limited to plant type, light conditions, soil aridity, average temperature, average rainfall, soil pH, soil type and other similar factors which impact the solubility of the applied boron in the soil as well as the need for boron by the plant(s) growing in the soil to which the boron-coated urea has been applied. However, as discussed herein, under most conditions, the disodium octaborate tetrahydrate and the potassium borate and/or potassium tetraborate tetrahydrate are “first uptake” forms of boron in that they are taken up first by the plant and the boric acid is a “subsequent uptake” form

The boron is applied to the urea prills either directly as a dry powder applied to a dry urea prill or the urea prills are first coated with a suitable sticking agent, as discussed herein.

It is of note that there are a large number of suitable sticking agents which will be readily apparent to one of skill in the art. For example, appropriate sticking agents may include but are by no means limited to molasses; starches; polymerized resins; hydrocarbon-based compounds; and vegetable oils such as, for example, canola oil.

Preferably, the potassium borate and/or potassium tetraborate tetrahydrate; disodium octaborate tetrahydrate; boric acid and mixtures thereof are of a particle size of at least 90% passing through a 100 mesh, U.S. standard sieve. In other embodiments, they are of a particle size of at least 75% passing through 325 mesh, U.S. standard sieve. In yet other embodiments, they are of a size between 100 to 325 mesh.

In some embodiments, the potassium borate and/or potassium tetraborate tetrahydrate; disodium octaborate tetrahydrate; boric acid or mixtures thereof in the form of a fine powder mixture is applied at from about 0.1% to about 2.5% (w/w) of the urea prill. In alternative embodiments, the powder mixture is applied at from about 0.1% to about 2.0% or from about 0.1% to about 1.5% or from about 0.3% to about 2.5% or from about 0.3% to about 2.0% or from about 0.3% to about 1.5% (w/w) of the urea prill. In some preferred embodiments, the plant-available boron fine powder is applied to the urea prills at from about 0.4% to about 1.5% w/w of the urea prills.

According to another aspect of the invention, there is provided a method of preparing a nitrogen based fertilizer product for plants with reduced ammonia volatilization loss, comprising: preparing a urea prill; coating said urea prill with a plant-available boron powder; said boron powder having a particle size of at least 90% passing through a 100 mesh standard screen sieve and being from about 0.1% to about 2.5% (w/w) of the urea prill.

As discussed above, the prior art teaches that boron can be used to inhibit urease. However, the boron has typically not been applied to the urea in a form that was suitable for uptake by the plants, especially for early uptake.

While application of a dry fine powder of a micronutrient to a dry agronomic carrier such as a urea prill was first disclosed in published PCT application WO 2002/38521, the benefits of the combination of plant-available boron and urea on early plant growth was not previously realized.

In fact, as discussed herein, initially, there was concern that the inhibition of volatilization was not as pronounced as was obtained with AGROTAIN® (liquid urease inhibitor), the active ingredient of which is the urease inhibitor N-(n-butyl) thiophosphoric triamide (NBPT), both in terms of duration and in the degree of cumulative ammonia volatilization reduction.

Specifically, as demonstrated herein, the boron coated urea prills of the invention reduced both ammonia volatilization and cumulative ammonia-N volatilization for up to 6 days following application compared to controls. AGROTAIN on the other hand reduced ammonia volatilization and cumulative ammonia-N volatilization to a much greater extent for over 17 days.

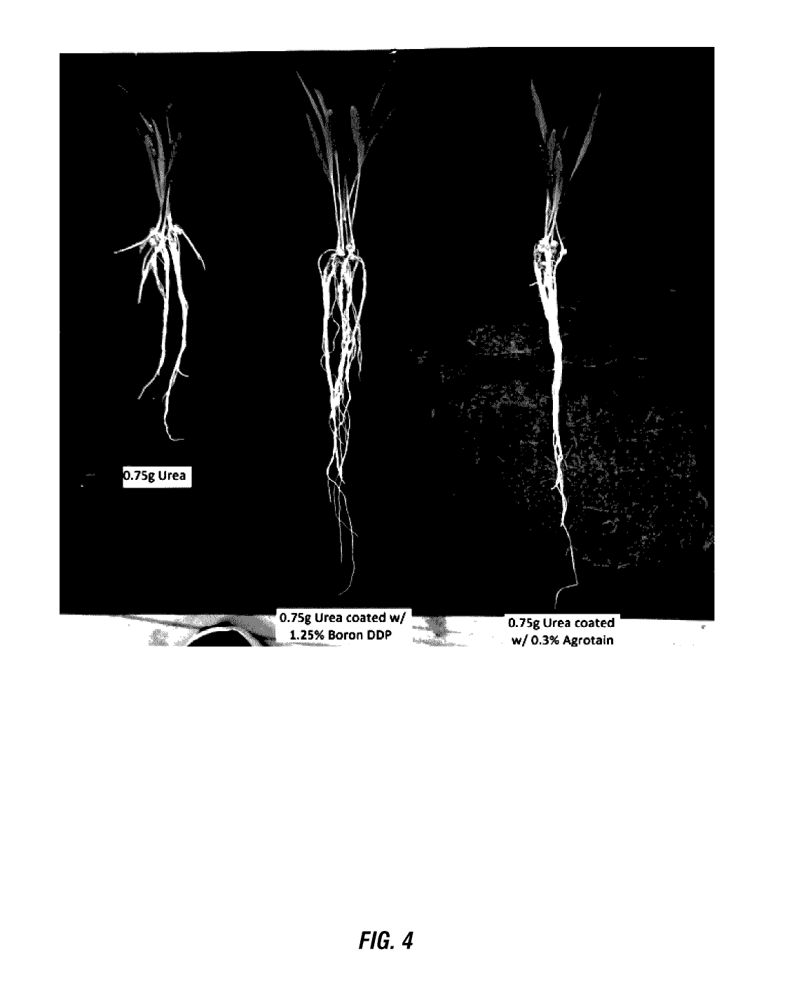

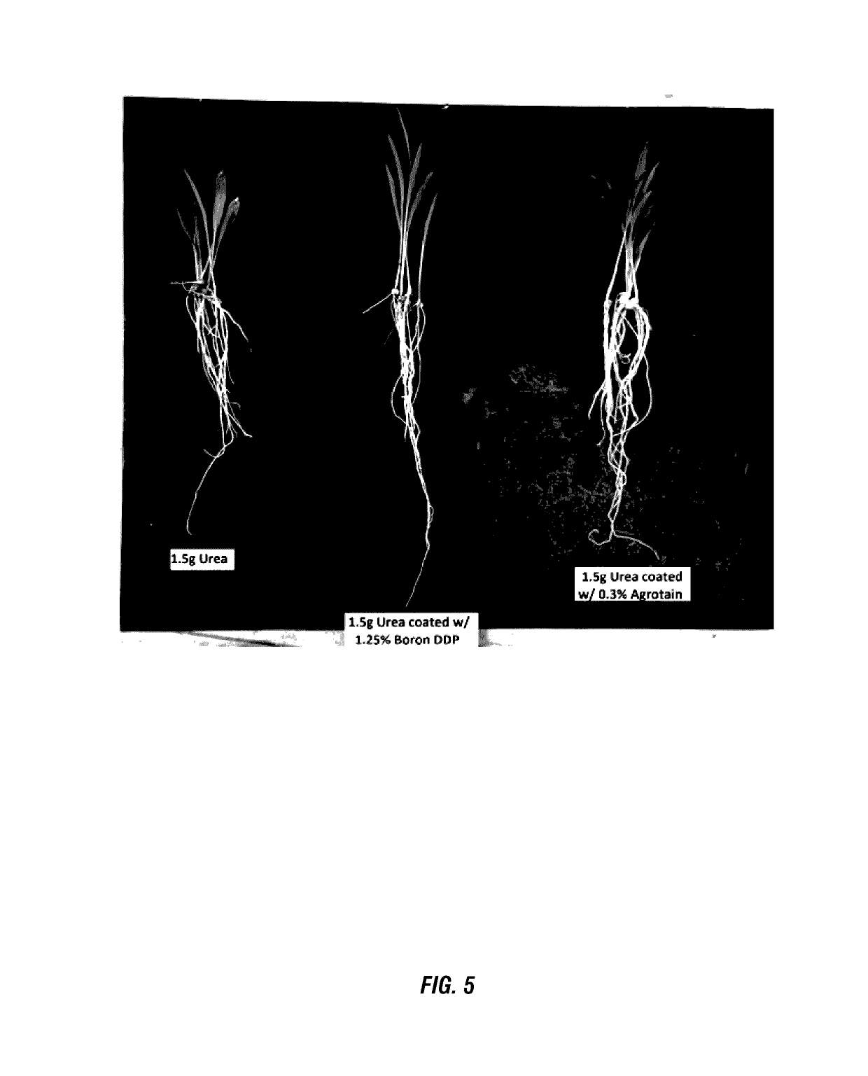

However, as shown in FIGS. 4 and 5 and as discussed below, there was a significantly better growth pattern observed with corn plants fertilized with the boron-coated urea prills of the invention compared to those fertilized with AGROTAIN.

Specifically, as shown in FIG. 4, the 0.75 g urea prills coated with 1.25% plant-available boron had longer “shoots” compared to the untreated control urea prills and the AGROTAIN treated urea prills. Furthermore, the root structure in the boron-coated urea-fertilized plant is much longer than the uncoated urea control. While the maximum root length between the AGROTAIN-coated urea-fertilized plant and the boron-coated urea-fertilized plant are similar, the roots are more extensive and more developed in the boron-coated urea-fertilized plant.

In FIG. 5, 1.5 g urea prills were used. As can be seen therein, the boron-coated urea-fertilized plant had longer shoots and roots.

As is known by those of skill in the art, the first five days are generally the most critical for plant growth as a growing plant may not be able to utilize the applied urea immediately after application.

Specifically, application of the boron-urea prill fertilizer products described herein provides both nitrogen and boron for the seed as growth of the seed starts. Furthermore, nitrogen and boron are provided prior to seedling emergence as well as early on in seedling growth.

Furthermore, as discussed herein, volatilization is reduced during the initial stages of seedling growth and the growing plant is supplied with a source of boron which further promotes initial plant growth to a greater degree than expected by either reduction of volatilization or supplying boron to the plant.

That is, as discussed herein, the urea prills are coated with a fine powder of boron, preferably a mixture of different plant available forms of boron. The prills are either dry coated directly with the boron powder or as discussed herein a sticking agent is used which helps promote adherence of the fine powder of boron to the urea prills. Specifically, the small size of the boron powder particles results in the particles adhering to the urea prills due to the intermolecular forces of attraction and electrostatic charges, as discussed herein. As will be appreciated by one of skill in the art, this is in contrast with other methods described in the art such as the use of a binding agent or melting of either the urea or boron or by otherwise chemically binding the boron to the urea prill. As such, the boron powder is applied to the urea prill in a manner that does not damage the structural integrity of the urea prill and the boron remains available for uptake by the plant, that is, the boron is not fused or bonded to the urea prill and is not in a form that is unsuitable for plant uptake. As a consequence, the boron is able to inhibit urease in the soil but is also available for the growing plant. As a result of this arrangement, the growing plant is supplied more nitrogen (less volatilization) and more boron (provided in a plant-available form) than with prior art low volatilization nitrogen fertilizers.

As discussed herein, urea prills were coated directly with a fine powder of boron at approximately 1.25% w/w of the urea prills, referred to herein as “MAX Boron”. Urea prills were also mixed with 0.5% (v/w urea prills) canola oil which was used as an adhering or “sticking” agent and then coated with 1.35% (w/w of the urea prills) boron fine powder as discussed above.

For comparison purposes, AGROTAIN®, a liquid urease inhibitor, was also applied to urea prills.

As controls, uncoated urea and urea coated with 1% potassium chloride (KCI), 1% sulfate of potash (SOP), and three phosphate coatings were used.

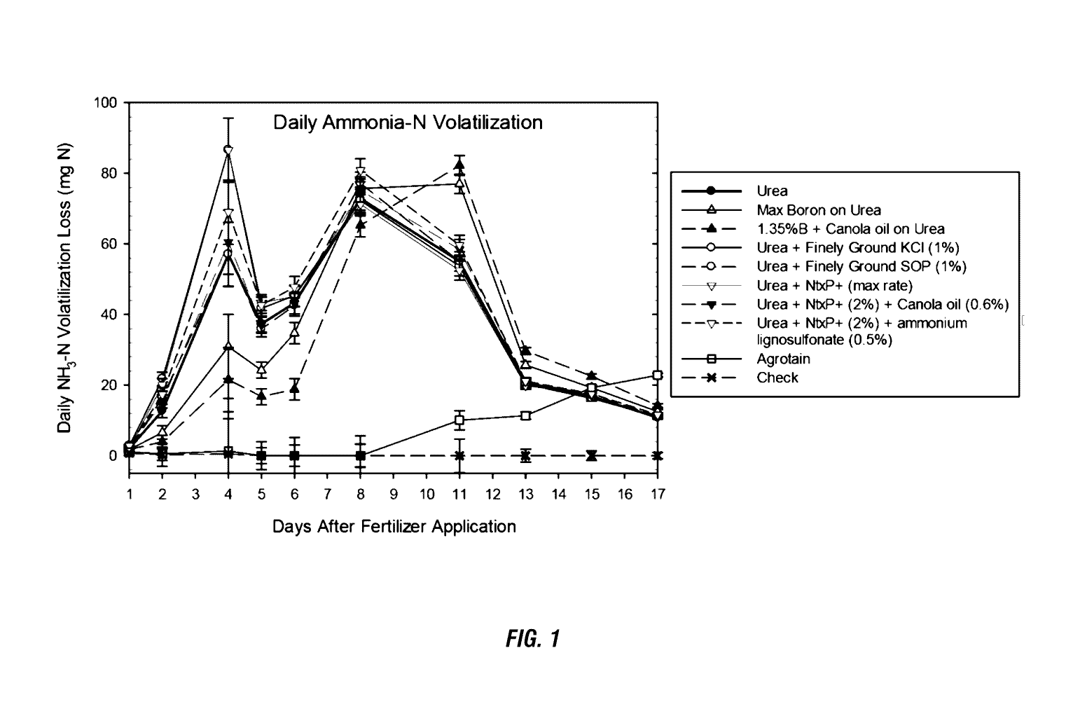

As can be seen in FIG. 1, both MAX Boron and Boron plus canola oil significantly reduced ammonia volatilization compared to the controls up to 6 days following application.

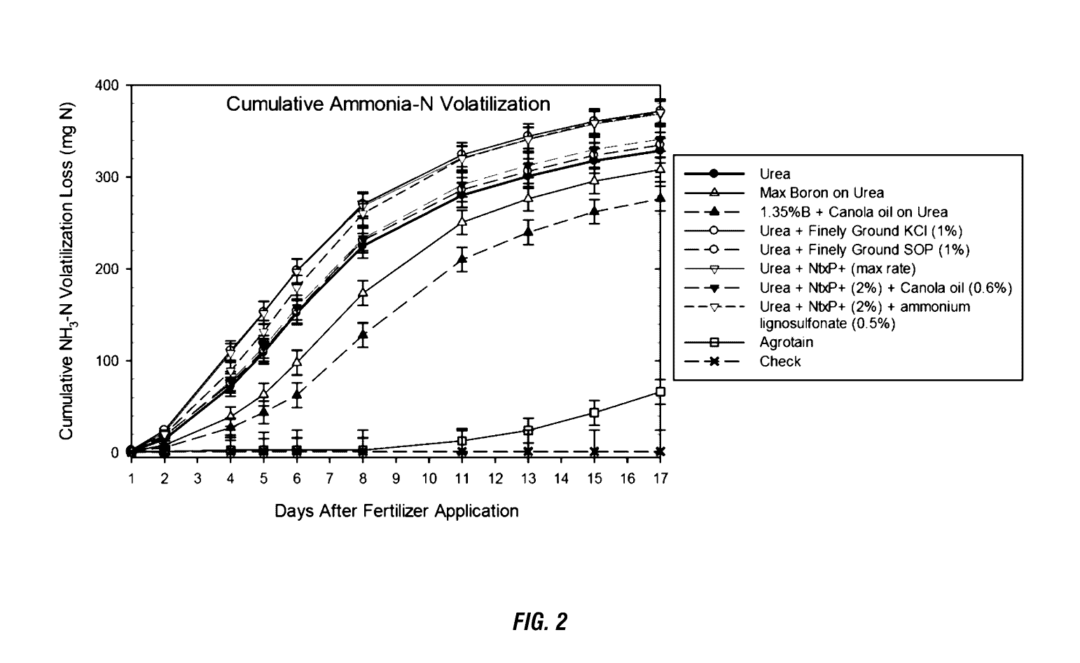

Furthermore, as shown in FIG. 2, there was also significant reduction in cumulative ammonia-N volatilization over time in both MAX Boron and Boron plus canola oil.

According to one embodiment of the invention, there is provided a urea prill coated with a plant-available boron powder wherein the plant available boron powder is applied to the urea prill at a particle size of at least 90% passing through a 100 mesh at 0.1-2.5% (w/w) of the urea prill.

According to one embodiment of the invention, there is provided a method of improving or promoting early growth of a plant comprising: providing a plant, a seed or a seedling a fertilizer product comprising a urea prill coated with a plant-available boron powder wherein the plant available boron powder is applied to the urea prill at a particle size of at least 90% passing through a 100 mesh at 0.1-2.5% (w/w); and growing the plant, the seed or the seedling under suitable growth conditions.

As will be appreciated by one of skill in the art, the coated urea prill is provided to the plant, seed or seedling by applying the coated urea prill to soil in which the plant, seed or seedling has been planted and/or is growing.

As will be apparent to one of skill in the art, the early growth of the plant is increased or promoted or improved compared to a similar plant, seed or seedling provided an uncoated urea prill under similar growth conditions, as discussed herein.

As will be understood by one of skill in the art, “early growth” refers to the initial growth of a plant, seed or seedling, for example, the first 28 days of growth; the first 21 days of growth; the first 14 days of growth or the first 7 days of growth.

In some embodiments, the plant-available boron powder is of a particle size of at least 75% passing through a 325 mesh or of a particle size between 100 to 325 mesh.

In some embodiments, as discussed above, the plant-available boron powder comprises potassium borate and/or potassium tetraborate tetrahydrate; and disodium octaborate tetrahydrate. Specifically, as discussed above, potassium borate, disodium octaborate tetrahydrate and potassium tetraborate tetrahydrate are fast-uptake or first-uptake forms of boron which will be taken up during early plant growth as these forms of boron are available to the plant on application of the boron-coated urea prill to the soil in which the plant is growing.

In some embodiments, the plant-available boron powder further comprises boric acid. As discussed above, boric acid is a slow uptake form of boron and will be available to the plant starting approximately 10 days after application of the boron-coated urea prill to the soil. This provides a source of boron for this stage of plant growth.

In other embodiments, the plant-available boron powder comprises disodium octaborate tetrahydrate, potassium borate and/or potassium tetraborate tetrahydrate, and boric acid or the plant-available boron powder is selected from the group consisting of potassium borate, disodium octaborate tetrahydrate, potassium tetraborate tetrahydrate, boric acid and mixtures thereof.

For example, the plant-available boron powder may be a mixture comprising 50-70% (w/w) disodium octaborate tetrahydrate, 15-25% (w/w) potassium borate and/or potassium tetraborate tetrahydrate, and 10-20% (w/w) boric acid.

Alternatively, the plant-available boron powder may be a mixture comprising 50-70% (w/w) disodium octaborate tetrahydrate, 15-25% (w/w) potassium tetraborate tetrahydrate, and 10-20% (w/w) boric acid.

As discussed above, the plant-available boron powder may be applied directly to the urea prill or the urea prill may be coated with a sticking agent prior to applying the plant-available boron powder to the urea prill.

The plant-available boron powder may be applied to the urea prill at from about 0.1% to about 2.0% (w/w), from about 0.3% to about 2.0% (w/w), from about 0.5% to about 2.0% (w/w), from about 0.1% to about 1.5% (w/w),from about 0.3% to about 1.5% (w/w) or from about 0.5% to about 1.5% (w/w) of the urea prill.

The invention will now be further described by way of examples. However, the invention is not necessarily limited by the examples.

### EXAMPLES

Greenville-Ioam (Fine, kaolinitic, thermic Rhodic Kandiudults), pH=6.2, organic matter=1.4 percent, total nitrogen=0.6 percent, CEC=5.2 cmol/kg was used to quantify ammonia volatilization losses from the coated urea prills under aerobic soil conditions. The nitrogen sources were applied at a rate of 1.06 g nitrogen (the equivalent of 200 kg N ha⁻¹) to 8 kg soil in volatilization pots, with an inner diameter of 26 cm. The fertilizer granules (urea prills) were uniformly distributed on the soil surface. Soil moisture content throughout the volatilization period was maintained at 75% field moisture capacity. The experiment included a total of 30 pots comprised of different N products and controls (10 treatments) and three replications (summarized in Table 1).

The pots were sealed tight and provided air inflow from a compressed air system and outflow to the acid traps. Air was passed through an acid scrubber to remove any NH₃ from the air and humidified before entering the pots. The airflow rate was adjusted to 5 L min⁻¹ for each pot to allow for complete mixing and maximum removal of any ammonia formed. All ammonia outflow from the pots was captured in phosphoric acid traps. During the first three days, these traps were sampled and changed on a daily basis. The samplings were done on alternate days during the latter stages of the experiment when the volatilization rate dropped.

The time intervals for NH₃—N collection were as follows: 1, 2, 4, 5, 6, 8, 11, 13, 15 and 17 days.

Solutions from acid traps were analyzed for ammoniacal-N with a Skalar SAN^{plus} segmented flow at least two to three times a week. The automated procedure for ammoniacal-N determination was based on the modified Berthelot reaction (Krom, 1980, Analyst 105:305-316; Searle, 1984, Analyst 109: 549-565). The spectrophotometric determination of ammonia complex was done at 680 nm. Air temperatures in the greenhouse and soil temperature in the pots were taken from selected treatments.

Overall, there were significant differences in ammonia-N volatilization loss (mg N loss) among tested coated urea prills days after fertilization application and treatment×day interaction. Ammonia-N volatilization loss from uncoated urea peaked at 4-6 days after N application and was significantly higher than all of the coated urea prills (FIG. 1, Table 2). However, the volatilization loss for many tested prills was artificially higher on day 4 because the sampling on day 3 was combined with day 4 due to bad weather in the area. Overall volatilization losses from control (no urea prills applied), Agrotain, 1.35% Boron+0.5% Canola oil on Urea, Max Boron on Urea and Urea+finely ground KCI (1%) were significantly lower than urea during the first five days (FIG. 1, Table 2). Significantly, the ammonia-N volatilization loss from 1.35% Boron, 0.5% Canola oil on Urea was as low as Agrotain during the first four days of the study.

During days 6-11, most coated prills (Urea+finely ground SOP (1%), Urea+finely ground KCI (1%), Urea+NtxP+(max rate), Urea+NtxP+(2%)+Canola oil (0.6%), Urea+P (0.63%), Urea+P (2%)+Canola Oil (0.6%) and Urea+P (2%)+ammonium lignosulfonate (0.5%)) had similar volatilization loss as urea. However, up to day 6, both urea prills coated with boron had significantly lower volatilization loss than urea (Table 3). On day 11, Max Boron on Urea had a significantly higher loss, while 1.35% Boron, 0.5% Canola oil on Urea had similar loss to urea. The Agrotain coated prill continued to have significantly lower losses than urea and all the other products. During the last five days of the study (days 13-17), most coated prills had similar volatilization losses to the uncoated urea prills, with the exception of Agrotain, which continued to have significantly lower losses (Table 4). In contrast, some of the products that had higher volatilization loss than Agrotain during the first 13 days had significantly lower ammonia-N volatilization loss by day 17. This was because much of the ammonia-N had already been lost, as shown in FIG. 1.

### Cumulative Ammonia Volatilization Loss

Cumulative ammonia volatilization (mg N loss) was significantly higher on application of uncoated urea prills, Urea+finely ground SOP (1%), Urea+finely ground KCI (1%), Urea+P (0.63%), Urea+P (2%)+Canola Oil (0.6%) and Urea+P (2%)+ammonium lignosulfonate (0.5%) during the first five days after fertilizer application when compared with Agrotain, 1.35% Boron+0.5% Canola oil on Urea and Max Boron on Urea (Table 5, FIG. 2). The ranking for this period was Urea+finely ground KCI (1%)=Urea+P (0.63%)≧Urea+P (2%)+ammonium lignosulfonate (0.5%)≧Urea+P+(2%)+Canola oil (0.6%)>Urea+finely ground SOP 1% ≧urea>Max Boron on Urea=1.35% Boron, 0.5% Canola oil on Urea>Agrotain=control (zero N).

The cumulative ammonia-N volatilization loss during days 6-11 was similar for all products except Agrotain and control, which had significantly lower losses (Table 5). During the last phase of the volatilization study, most nitrogen losses from all urea products had already occurred; hence, there were few differences among products in the cumulative loss during days 13-17 (Table 5).

Cumulative (total) NH₃−N volatilization (mg N loss) was significantly lower with 1.35% Boron+0.5% Canola oil on Urea than on application of uncoated urea (Table 6). Max Boron on Urea also had lower cumulative NH₃−N volatilization than urea. Overall, the 1.35% Boron+0.5% Canola oil on Urea had significantly lower volatilization loss than the other urea products and was also lower than Max Boron on Urea, but not significantly different. However, Agrotain was far more effective in reducing volatilization loss than the urea prills coated with boron powder.

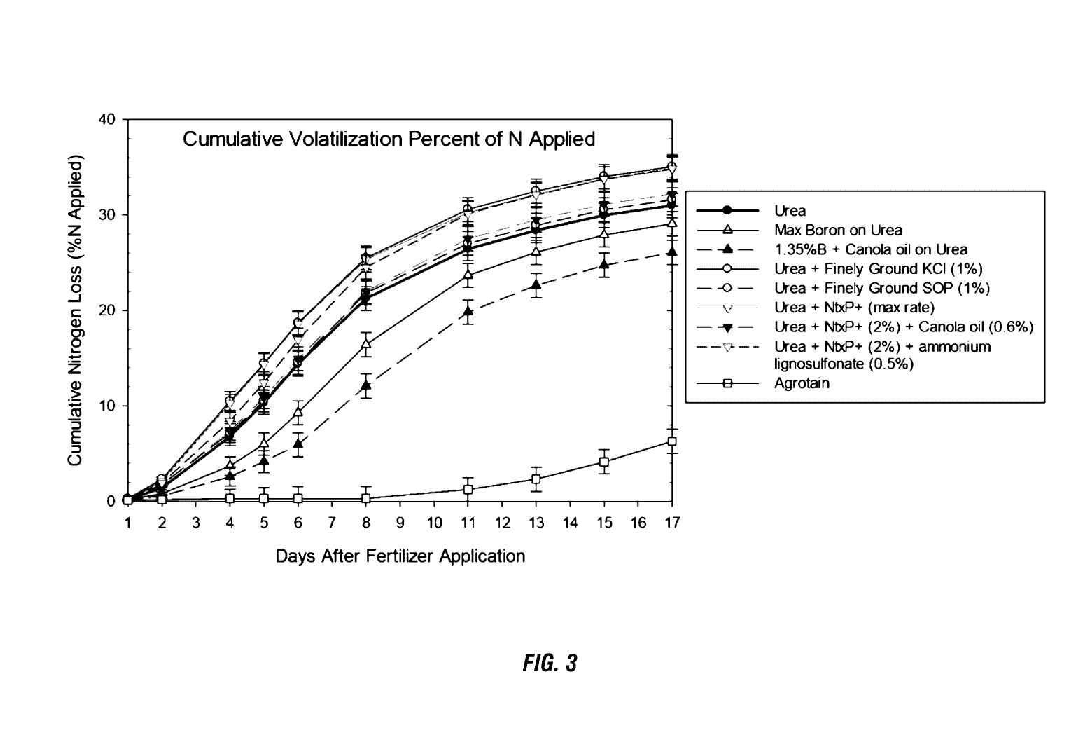

Total ammonia-N volatilization loss of 31% obtained with urea in this study is similar to the values reported in other studies. Coating urea with KCI, SOP and other coating such as in Urea+P did not reduce volatilization loss. The volatilization losses from Boron-coated products were 29% with Max Boron on Urea and 26% with 1.35% Boron +0.5% Canola oil on Urea (Table 6, FIG. 3).

The following fertilizer products—Max Boron on Urea and 1.35% Boron+0.5% Canola oil on Urea—had lower ammonia volatilization losses at 29% and 26% of applied nitrogen fertilizer compared with urea at 31%, respectively.

The incorporation of boron in both the Max Boron and 1.35% Boron+0.5% Canola oil on Urea coating provides boron as an essential micronutrient and further reduces the volatilization loss or improves the nitrogen use efficiency by the plant of urea.

Furthermore, not only did the other urea products not reduce volatilization loss, some of these products had significantly higher ammonia-N loss than the urea control.

1.35% Boron+0.5% Canola oil on Urea, resulted in 16% lower volatilization loss; and such reduction in volatilization loss will have significant effects on crop response due to both nitrogen retention and the added boron nutrition, as discussed herein and as shown in FIGS. 4 and 5. During the first five days after urea application, when the volatilization loss is generally the highest, 1.35% Boron+0.5% Canola oil on Urea had only 4% of applied N loss, had 6% loss while urea had>10% of applied N loss (Table 5). The nitrogen savings with 1.35% Boron+0.5% Canola oil on Urea and Max Boron on Urea were 60% and 42%, respectively, compared with urea during the first five days. As discussed above, the first five days in field conditions are generally the most critical as the plant may not be able to utilize the applied urea immediately after application.

In order to determine the synergistic benefit of using the boron powder as formulated to coat the urea prills, a greenhouse experiment was run using corn as the subject crop. The corn was seeded into trays that had been loaded with a light textured soil that was treated with (a) a 100 kg per ha rate of urea or (b) a 200 kg per ha rate of urea. There were three subtreatments within the urea treatments—(i) urea uncoated, (ii) urea coated with 1.25% Wolf Trax Boron coating or (iii) urea co-treated with AGROTAIN. The corn was grown for 14 days and then harvested and examined. Results are shown in FIGS. 4 and 5.

Specifically, as shown in FIG. 4, the 0.75 g urea prills coated with 1.25% plant-available boron had longer “shoots” compared to the untreated control urea prills and the AGROTAIN treated urea prills. Furthermore, the root structure in the boron-coated urea-fertilized plant is much longer than the uncoated urea control. While the maximum root length between the AGROTAIN-coated urea-fertilized plant and the boron-coated urea-fertilized plant are similar, the roots are more extensive and more developed in the boron-coated urea-fertilized plant.

In FIG. 5, 1.5 g urea prills were used. As can be seen therein, the boron-coated urea-fertilized plant had longer shoots and roots.

The scope of the claims should not be limited by the preferred embodiments set forth in the examples but should be given the broadest interpretation consistent with the description as a whole.

TABLE 1
Treatment descriptions and amount of fertilizer
product applied to each pot.

| | | | | N | Product |
|---|---|---|---|---|---|
| Pot | | Trt | | Content | Rate |
| No. | Rep | No. | Product Description | (%) | (g/pot) |
| 1 | 1 | 1 | Urea | 46.51 | 2.279 |
| 2 | 1 | 2 | Urea + Max Boron | 46.1 | 2.299 |
| 3 | 1 | 3 | Urea + 1.35% Boron + | 45.44 | 2.333 |
| | | | Canola Oil (0.5%) | | |
| 4 | 1 | 4 | Urea + KCl (1%) | 46.26 | 2.291 |
| 5 | 1 | 5 | Urea + SOP (1%) | 46.37 | 2.286 |
| 6 | 1 | 6 | Urea + P (0.63%) | 46.25 | 2.292 |
| 7 | 1 | 7 | Urea + P (2%) + | 45.61 | 2.324 |
| | | | Canola Oil (0.6%) | | |
| 8 | 1 | 8 | Urea + P (2%) + | 45.65 | 2.322 |
| | | | ammonium lignosulfonate | | |
| | | | (0.5%) | | |
| 9 | 1 | 9 | AGROTAIN | 46 | 2.304 |
| 10 | 1 | 10 | Control | 0 | 0.000 |
| 11 | 2 | 1 | Urea | 46.51 | 2.279 |
| 12 | 2 | 2 | Urea + Max Boron | 46.1 | 2.299 |
| 13 | 2 | 3 | Urea + 1.35% Boron + | 45.44 | 2.333 |
| | | | Canola Oil (0.5%) | | |
| 14 | 2 | 4 | Urea + KCl (1%) | 46.26 | 2.291 |
| 15 | 2 | 5 | Urea + SOP (1%) | 46.37 | 2.286 |
| 16 | 2 | 6 | Urea + P (0.63%) | 46.25 | 2.292 |
| 17 | 2 | 7 | Urea + P (2%) + | 45.61 | 2.324 |
| | | | Canola Oil (0.6%) | | |
| 18 | 2 | 8 | Urea + P (2%) + | 45.65 | 2.322 |
| | | | ammonium lignosulfonate | | |
| | | | (0.5%) | | |
| 19 | 2 | 9 | AGROTAIN | 46 | 2.304 |
| 20 | 2 | 11 | AGROTAIN-IFDC (Prill) | 46 | 2.304 |
| 21 | 3 | 1 | Urea | 46.51 | 2.279 |
| 22 | 3 | 2 | Urea + Max Boron | 46.1 | 2.299 |
| 23 | 3 | 3 | Urea + 1.35% Boron + | 45.44 | 2.333 |
| | | | Canola Oil (0.5%) | | |
| 24 | 3 | 4 | Urea + KCl (1%) | 46.26 | 2.291 |
| 25 | 3 | 5 | Urea + SOP (1%) | 46.37 | 2.286 |
| 26 | 3 | 6 | Urea + P (0.63%) | 46.25 | 2.292 |
| 27 | 3 | 7 | Urea + P (2%) + | 45.61 | 2.324 |
| | | | Canola Oil (0.6%) | | |
| 28 | 3 | 8 | Urea + P (2%) + | 45.65 | 2.322 |
| | | | ammonium lignosulfonate | | |
| | | | (0.5%) | | |
| 29 | 3 | 9 | AGROTAIN | 46 | 2.304 |
| 30 | 3 | 10 | Control | 0 | 0.000 |

TABLE 2
Comparison of daily NH₃—N volatilization loss
from selected products during the first five days.

| | | | Mean | Std | |
|---|---|---|---|---|---|
| Day | A | B | Diff | Err | Prob_T |
| 1 | Urea + KCl | Urea | 0.72 | 0.44 | 0.10 |
| 2 | Urea + KCl | Urea | 9.06 | 2.66 | 0.00 |
| 4 | Urea + KCl | Urea | 29.55 | 12.84 | 0.02 |
| 5 | Urea + KCl | Urea | 4.43 | 3.25 | 0.17 |
| 1 | Urea + Max | Urea | −0.36 | 0.44 | 0.42 |
| | Boron | | | | |
| 2 | Urea + Max | Urea | −6.13 | 2.66 | 0.02 |
| | Boron | | | | |
| 4 | Urea + Max | Urea | −26.19 | 12.84 | 0.04 |
| | Boron | | | | |
| 5 | Urea + Max | Urea | −13.10 | 3.25 | 0.00 |
| | Boron | | | | |
| 1 | Urea + 1.35% | Urea | −0.32 | 0.44 | 0.46 |
| | Boron + Canola | | | | |
| | Oil (0.5%) | | | | |
| 2 | Urea + 1.35% | Urea | −8.76 | 2.66 | 0.00 |
| | Boron + Canola | | | | |
| | Oil (0.5%) | | | | |
| 4 | Urea + 1.35% | Urea | −35.54 | 12.84 | 0.01 |
| | Boron + Canola | | | | |
| | Oil (0.5%) | | | | |
| 5 | Urea + 1.35% | Urea | −20.59 | 3.25 | 0.00 |
| | Boron + Canola | | | | |
| | Oil (0.5%) | | | | |
| 1 | Urea + P (0.63%) | Urea | −0.01 | 0.44 | 0.98 |
| 2 | Urea + P (0.63%) | Urea | 7.33 | 2.66 | 0.01 |
| 4 | Urea + P (0.63%) | Urea | 29.49 | 12.84 | 0.02 |
| 5 | Urea + P (0.63%) | Urea | 6.07 | 3.25 | 0.06 |
| 1 | Control | Urea | −1.32 | 0.62 | 0.04 |
| 2 | Control | Urea | −12.45 | 3.76 | 0.00 |
| 4 | Control | Urea | −56.58 | 18.16 | 0.00 |
| 5 | Control | Urea | −37.32 | 4.59 | 0.00 |
| 1 | AGROTAIN | Urea | −1.00 | 0.44 | 0.02 |
| 2 | AGROTAIN | Urea | −12.17 | 2.66 | 0.00 |
| 4 | AGROTAIN | Urea | −55.72 | 12.84 | 0.00 |
| 5 | AGROTAIN | Urea | −37.32 | 3.25 | 0.00 |
| 1 | AGROTAIN | Urea + 1.35% | −0.68 | 0.44 | 0.12 |
| | | Boron + Canola | | | |
| | | Oil (0.5%) | | | |
| 2 | AGROTAIN | Urea + 1.35% | −3.41 | 2.66 | 0.20 |
| | | Boron + Canola | | | |
| | | Oil (0.5%) | | | |
| 4 | AGROTAIN | Urea + 1.35% | −20.18 | 12.84 | 0.12 |
| | | Boron + Canola | | | |
| | | Oil (0.5%) | | | |
| 5 | AGROTAIN | Urea + 1.35% | −16.72 | 3.25 | 0.00 |
| | | Boron + Canola | | | |
| | | Oil (0.5%) | | | |
| 1 | AGROTAIN | Urea + Max | −0.64 | 0.44 | 0.14 |
| | | Boron | | | |
| 2 | AGROTAIN | Urea + Max | −6.04 | 2.66 | 0.02 |
| | | Boron | | | |
| 4 | AGROTAIN | Urea + Max | −29.54 | 12.84 | 0.02 |
| | | Boron | | | |
| 5 | AGROTAIN | Urea + Max | −24.22 | 3.25 | 0.00 |
| | | Boron | | | |

TABLE 3
Comparison of daily NH₃—N volatilization
loss from selected products during days 6-11.

| | | | Mean | Std | |
|---|---|---|---|---|---|
| Day | A | B | Diff | Err | Prob_T |
| 6 | Urea + Max Boron | Urea | −8.56 | 4.24 | 0.04 |
| 8 | Urea + Max Boron | Urea | 2.83 | 4.60 | 0.54 |
| 11 | Urea + Max Boron | Urea | 21.92 | 3.89 | 0.00 |
| 6 | Urea + 1.35% Boron + | Urea | −24.47 | 4.24 | 0.00 |
| | Canola Oil (0.5%) | | | | |
| 8 | Urea + 1.35% Boron + | Urea | −7.56 | 4.60 | 0.10 |
| | Canola Oil (0.5%) | | | | |
| 11 | Urea + 1.35% Boron + | Urea | 27.19 | 3.89 | 0.00 |
| | Canola Oil (0.5%) | | | | |
| 6 | Control | Urea | −43.25 | 5.99 | 0.00 |
| 8 | Control | Urea | −72.87 | 6.50 | 0.00 |
| 11 | control | Urea | −55.07 | 5.51 | 0.00 |
| 6 | AGROTAIN | Urea | −43.25 | 4.24 | 0.00 |
| 8 | AGROTAIN | Urea | −72.87 | 4.60 | 0.00 |
| 11 | AGROTAIN | Urea | −45.01 | 3.89 | 0.00 |

TABLE 4
Comparison of daily NH₃—N volatilization loss from
selected products during the last 5 days of the study.

| | | | Mean | Std | |
|---|---|---|---|---|---|
| Day | A | B | Diff | Err | Prob_T |
| 13 | Urea + Max | Urea | 4.994 | 1.471 | 0.001 |
| | Boron | | | | |
| 15 | Urea + Max | Urea | 2.460 | 1.082 | 0.024 |
| | Boron | | | | |
| 17 | Urea + Max | Urea | 1.706 | 0.700 | 0.016 |
| | Boron | | | | |
| 13 | Urea + 1.35% | Urea | 8.958 | 1.471 | 0.000 |
| | Boron + Canola | | | | |
| | Oil (0.5%) | | | | |
| 15 | Urea + 1.35% | Urea | 5.677 | 1.082 | 0.000 |
| | Boron + Canola | | | | |
| | Oil (0.5%) | | | | |
| 17 | Urea + 1.35% | Urea | 3.356 | 0.700 | 0.000 |
| | Boron + Canola | | | | |
| | Oil (0.5%) | | | | |
| 13 | Control | Urea | −20.696 | 2.081 | 0.000 |
| 15 | Control | Urea | −16.810 | 1.530 | 0.000 |
| 17 | control | Urea | −10.810 | 0.989 | 0.000 |
| 13 | AGROTAIN | Urea | −9.353 | 1.471 | 0.000 |
| 15 | AGROTAIN | Urea | 2.449 | 1.082 | 0.025 |
| 17 | AGROTAIN | Urea | 11.982 | 0.700 | 0.000 |
| 13 | AGROTAIN | Urea + Max | −14.347 | 1.471 | 0.000 |
| | | Boron | | | |
| 15 | AGROTAIN | Urea + Max | −0.011 | 1.082 | 0.992 |
| | | Boron | | | |
| 17 | AGROTAIN | Urea + Max | 10.276 | 0.700 | 0.000 |
| | | Boron | | | |
| 13 | AGROTAIN | Urea + 1.35% | −18.310 | 1.471 | 0.000 |
| | | Boron + Canola | | | |
| | | Oil (0.5%) | | | |
| 15 | AGROTAIN | Urea + 1.35% | −3.228 | 1.082 | 0.003 |
| | | Boron + Canola | | | |
| | | Oil (0.5%) | | | |
| 17 | AGROTAIN | Urea + 1.35% | 8.626 | 0.700 | 0.000 |
| | | Boron + Canola | | | |
| | | Oil (0.5%) | | | |

TABLE 5
Mean cumulative NH₃—N volatilization loss
during three periods of the volatilization study.

| | Mean | StdErr | % Loss | Mean | StdErr | Mean | StdErr |
|---|---|---|---|---|---|---|---|
| Treatment | Days 0-5 | | | Days 6-11 | | Days 13-17 | |
| Control | 1.46 | 21.14 | — | 0.00 | 12.27 | 0.31 | 3.40 |
| AGROTAIN | 2.91 | 12.21 | 0.3 | 10.06 | 7.08 | 53.39 | 1.97 |
| Urea + 1.35% Boron + | 43.90 | 12.21 | 4.1 | 166.36 | 7.08 | 66.31 | 1.97 |
| Canola Oil (0.5%) | | | | | | | |
| Urea + Max Boron | 63.35 | 12.21 | 6.0 | 187.38 | 7.08 | 57.48 | 1.97 |
| Urea | 109.12 | 12.21 | 10.3 | 171.19 | 7.08 | 48.32 | 1.97 |
| Urea + SOP (1%) | 111.50 | 12.21 | 10.5 | 174.79 | 7.08 | 48.60 | 1.97 |
| Urea + P (2%) + | 115.07 | 12.21 | 10.8 | 176.77 | 7.08 | 49.58 | 1.97 |
| Canola Oil (0.6%) | | | | | | | |
| Urea + P (2%) + | 131.88 | 12.21 | 12.4 | 188.34 | 7.08 | 50.23 | 1.97 |
| ammonium lignosulfonate | | | | | | | |
| (0.5%) | | | | | | | |
| Urea + P (0.63%) | 152.00 | 12.21 | 14.3 | 168.88 | 7.08 | 47.89 | 1.97 |
| Urea + KCl (1%) | 152.89 | 12.21 | 1.4 | 171.32 | 7.08 | 47.49 | 1.97 |

TABLE 6
Comparison of cumulative NH₃—N volatilization loss after
17 days as mg N loss and percentage of applied N, Products with
common letters are not significantly different at p < 0.05.

| | | | | Cumulative Loss |
|---|---|---|---|---|
| Treatment | Mean | StdErr | Sig Diff | (% N applied) |
| Urea + KCl (1%) | 371.70 | 13.47 | A | 35.1 |
| Urea + P (2%) + | 370.45 | 13.47 | A | 34.9 |
| ammonium | | | | |
| lignosulfonate (0.5%) | | | | |
| Urea + P (0.63%) | 368.76 | 13.47 | A | 34.8 |
| Urea + P (2%) + Canola | 341.42 | 13.47 | AB | 32.2 |
| Oil (0.6%) | | | | |
| Urea + SOP (1%) | 334.89 | 13.47 | AB | 31.6 |
| Urea | 328.63 | 13.47 | B | 31.0 |
| Urea + Max Boron | 308.21 | 13.47 | BC | 29.1 |
| Urea + 1.35% Boron + | 276.57 | 13.47 | C | 26.1 |
| Canola Oil (0.5%) | | | | |
| Agrotain | 66.36 | 13.47 | D | 6.3 |
| Control | 1.46 | 23.32 | E | — |

1. A method of improving early growth of a plant comprising:
providing a plant, a seed or a seedling a fertilizer product comprising a urea prill coated with a plant-available boron powder wherein the plant-available boron powder is applied to the urea prill at a particle size of at least 90% passing through a 100 mesh at 0.1-2.5% (w/w) of the urea prill; and
growing the plant, the seed or the seedling under suitable growth conditions.

2. The method according to claim 1 wherein the plant-available boron powder is of a particle size of at least 75% passing through a 325 mesh.

3. The method according to claim 1 wherein the plant-available boron powder is of a particle size between 100 to 325 mesh.

4. The method according to claim 1 wherein the plant-available boron powder comprises potassium borate, disodium octaborate tetrahydrate or potassium tetraborate tetrahydrate.

5. The method of claim 4 wherein the plant-available boron powder further comprises boric acid.

6. The method according to claim 1 wherein the plant-available boron powder comprises 50-70% (w/w) disodium octaborate tetrahydrate, 15-25% (w/w) potassium tetraborate tetrahydrate, and 10-20% (w/w) boric acid.

7. The method according to claim 1 wherein the plant-available boron powder is selected from the group consisting of potassium borate, disodium octaborate tetrahydrate, potassium tetraborate tetrahydrate, boric acid and mixtures thereof.

8. The method according to claim 1 wherein the plant-available boron powder is applied directly to the urea prill.

9. The method according to claim 1 wherein the urea prill is coated with a sticking agent prior to applying the plant-available boron powder.

10. The method according to claim 1 wherein the plant-available boron powder is applied to the urea prill at from about 0.1% to about 2.0% (w/w) of the urea prill.

11. The method according to claim 1 wherein the plant-available boron powder is applied to the urea prill at from about 0.3% to about 2.0% (w/w) of the urea prill.

12. The method according to claim 1 wherein the plant-available boron powder is applied to the urea prill at from about 0.5% to about 2.0% (w/w) of the urea prill.

13. The method according to claim 1 wherein the plant-available boron powder is applied to the urea prill at from about 0.1% to about 1.5% (w/w) of the urea prill.

14. The method according to claim 1 wherein the plant-available boron powder is applied to the urea prill at from about 0.3% to about 1.5% (w/w) of the urea prill

15. The method according to claim 1 wherein the plant-available boron powder is applied to the urea prill at from about 0.5% to about 1.5% (w/w) of the urea prill

16. A urea prill coated with a plant-available boron powder wherein the plant available boron powder is applied to the urea prill at a particle size of at least 90% passing through a 100 mesh at 0.1-2.5% (w/w) of the urea prill.

17. The urea prill according to claim 16 wherein the plant-available boron powder is of a particle size of at least 75% passing through a 325 mesh.

18. The urea prill according to claim 16 wherein the plant available boron powder is of a particle size between 100 to 325 mesh.

19. The urea prill according to claim 16 wherein the plant-available boron powder comprises potassium borate, disodium octaborate tetrahydrate or potassium tetraborate tetrahydrate.

20. The urea prill of claim 19 wherein the plant-available boron powder further comprises boric acid.

21. The urea prill according to claim 16 wherein the plant-available boron powder comprises 50-70% (w/w) disodium octaborate tetrahydrate, 15-25% (w/w) potassium tetraborate tetrahydrate, and 10-20% (w/w) boric acid.

22. The urea prill according to claim 16 wherein the plant-available boron powder is selected from the group consisting of potassium borate, disodium octaborate tetrahydrate, potassium tetraborate tetrahydrate, boric acid and mixtures thereof.

23. The urea prill according to claim 16 wherein the plant-available boron powder is applied directly to the urea prill.

24. The urea prill according to claim 16 wherein the urea prill is coated with a sticking agent prior to applying the plant-available boron powder.

25. The urea prill according to claim 16 wherein the plant-available boron powder is applied to the urea prill at from about 0.1% to about 2.0% (w/w) of the urea prill.

26. The urea prill according to claim 16 wherein the plant-available boron powder is applied to the urea prill at from about 0.3% to about 2.0% (w/w) of the urea prill.

27. The urea prill according to claim 16 wherein the plant-available boron powder is applied to the urea prill at from about 0.5% to about 2.0% (w/w) of the urea prill.

28. The urea prill according to claim 16 wherein the plant-available boron powder is applied to the urea prill at from about 0.1% to about 1.5% (w/w) of the urea prill.

29. The urea prill according to claim 16 wherein the plant-available boron powder is applied to the urea prill at from about 0.3% to about 1.5% (w/w) of the urea prill.

30. The urea prill according to claim 16 wherein the plant-available boron powder is applied to the urea prill at from about 0.5% to about 1.5% (w/w) of the urea prill.

31. A method of preparing a nitrogen based fertilizer product for plants with reduced ammonia volatilization loss, comprising:
preparing a urea prill;
coating said urea prill with a plant available boron powder;
said boron powder having a particle size of at least 90% passing through a 100 mesh standard screen sieve and being from about 0.1% to about 2.5% (w/w) of the urea prill.

32. The method according to claim 31 wherein the plant-available boron powder is of a particle size of at least 75% passing through a 325 mesh.

33. The method according to claim 31 wherein the plant-available boron powder is of a particle size between 100 to 325 mesh.

34. The method according to claim 31 wherein the plant-available boron powder comprises potassium borate, disodium octaborate tetrahydrate or potassium tetraborate tetrahydrate.

35. The method of claim 34 wherein the plant-available boron powder further comprises boric acid.

36. The method according to claim 31 wherein the plant-available boron powder comprises 50-70% (w/w) disodium octaborate tetrahydrate, 15-25% (w/w) potassium tetraborate tetrahydrate, and 10-20% (w/w) boric acid.

37. The method according to claim 31 wherein the plant-available boron powder is selected from the group consisting of potassium borate, disodium octaborate tetrahydrate, potassium tetraborate tetrahydrate, boric acid and mixtures thereof.

38. The method according to claim 31 wherein the plant-available boron powder is applied directly to the urea prill.

39. The method according to claim 31 wherein the urea prill is coated with a sticking agent prior to applying the plant-available boron powder.

40. The method according to claim 31 wherein the plant-available boron powder is applied to the urea prill at from about 0.1% to about 2.0% (w/w) of the urea prill.

41. The method according to claim 31 wherein the plant-available boron powder is applied to the urea prill at from about 0.3% to about 2.0% (w/w) of the urea prill.

42. The method according to claim 31 wherein the plant-available boron powder is applied to the urea prill at from about 0.5% to about 2.0% (w/w) of the urea prill.

43. The method according to claim 31 wherein the plant-available boron powder is applied to the urea prill at from about 0.1% to about 1.5% (w/w) of the urea prill.

44. The method according to claim 31 wherein the plant-available boron powder is applied to the urea prill at from about 0.3% to about 1.5% (w/w) of the urea prill.

45. The method according to claim 31 wherein the plant-available boron powder is applied to the urea prill at from about 0.5% to about 1.5% (w/w) of the urea prill.
